(19) United States
(12) Patent Application Publication
(10) Pub. No.: US 2016/0097363 A1
(43) Pub. Date: Apr. 7, 2016

(54) TRANSPORTABLE GAS DEVICE

(71) Applicant: PRIDE OF THE HILLS MANUFACTURING, INC., Big Prairie, OH (US)

(72) Inventors: Curtis W. Murray, SR., Big Prairie, OH (US); Curtis W. Murray, JR., Wooster, OH (US); Leroy P. Whited, Elyria, OH (US); Dustin Baker, Shreve, OH (US)

(73) Assignee: PRIDE OF THE HILLS MANUFACTURING, INC.

(21) Appl. No.: 14/873,598

(22) Filed: Oct. 2, 2015

Related U.S. Application Data
(60) Provisional application No. 62/060,859, filed on Oct. 7, 2014.

(51) Int. Cl. F02M 67/06; F17C 7/00; F17C 13/08; F17C 1/00

(52) U.S. Cl. CPC F02M 67/06; F17C 1/00; F17C 7/00; F17C 13/08; F17C 2270/0134; F17C 2265/065; F17C 2250/032; F17C 2227/04; F17C 2223/036; F17C 2223/033; F17C 2205/0323; F17C 2205/0352; F17C 2205/0161; F17C 2265/066

(57) ABSTRACT

A mobile compressed natural gas (CNG) pressure reducing choke and heater unit are mounted to a trailer. The trailer is towable to a location that does not have a sales pipeline of CNG. The CNG has already been processed and is stored in a compressed storage station facility. The CNG then flows through an inlet and through a series of valves and then through the choke. The choke on the trailer chokes down the pressure of CNG directly from a compressed tank, usually on a separate semi-tractor. CNG is then heated, and used on site. The CNG input to this system may come from two distinct sources such that the pressure reduction can continuously occur without any readily observable delay by the user. There are outlet ports to connect to a diesel engine converted to run on CNG.

### CROSS REFERENCE TO RELATED APPLICATION

This application claims the benefit of U.S. Provisional Application Ser. No. 62/060,859, filed Oct. 7, 2014; the disclosure of which is entirely incorporated herein by reference.

### BACKGROUND OF THE INVENTION

1. Technical Field

The present invention relates generally devices in the oil and gas industry. More particularly, the present invention relates to a moveable trailer having a pressure reducing choke and compressed natural gas (CNG) heater unit mounted thereto. Specifically, the present invention relates to a moveable platform, a choke connected to the platform, and a heater unit connected to the platform configured to output CNG at a pressure combustible in a converted diesel engine at a remote site location that does not have access to a conventional CNG sales pipeline.

2. Background Information

Both natural gas and oil exploration and extraction require that wells are drilled to access the deep pockets of potential energy stored within the earth's crust. The pockets of fossil fuel stored within the earth have no relation or bearing for human development and civilization existing atop the earth's surface. This is why some oil and gas wells are located in the farthest reaches of the Arctic, the extreme dessert sands of the Middle East, and the deep waters of the oceans. Many other gas well sites are not as remote, but still not close to commercialized civilization, such as in the hilly region of Southern and Eastern Ohio, United States of America.

The rigs and drilling units that operate wells in remote locations often require significant amounts of power. Many of the drilling units utilize diesel engines that have been converted to run on compressed natural gas (CNG). These engines typically require that the pressure of CNG fed into the converted diesel engine be input at about 50 pounds per square inch (PSI). However, due to the remoteness of the well locations, there is rarely a conventional CNG sales pipeline at the well site.

### SUMMARY

Issues continue to exist with operating converted diesel engines on CNG at a well site remote from a CNG sales pipeline. The present invention addresses these and other issues by providing a device that allows a truck carrying highly pressurized CNG to be driven to a remote well site and unload its pressurized CNG contents/payload through the device so that a converted diesel engine may operate at the remote well site.

In one aspect, an embodiment of the invention may provide a transportable gas device comprising: a moveable platform; a choke connected to the platform configured to decrease pressure of compressed fuel moving therethrough; and a heater unit connected to the platform for heating a length of heater pipeline, the heater pipeline in fluid communication with the choke and downstream from the choke.

In another aspect, an embodiment of the invention may provide a transportable gas device comprising: a moveable platform; a choke connected to the moveable platform configured to decrease pressure of compressed fuel moving therethrough; and a heater unit connected to the moveable platform in downstream fluid communication with the choke to warm the compressed fuel after the pressure has been decreased by the choke.

In another aspect, another embodiment of the invention may provide a method comprising the steps of: providing a moveable platform and a choke fluidly coupled to a heater unit mounted on the moveable platform; coupling the choke with a first compressed fuel source via pipeline or tubing; moving fuel from the source towards the choke; and decreasing the fuel pressure as the fuel moves through the choke.

In another aspect, the invention may provide a device comprising: a drop-neck trailer for attaching to a truck via a fifth-wheel hitch assembly located at the front end the trailer; a platform on the trailer extending rearward from adjacent the front end; a pair of inlets mounted to the platform on the trailer on a respective left and right side of the trailer; high pressure gas pipeline for therein containing pressurized compressed natural gas flowing from a CNG tank on a vehicle distinct from the trailer; a choke mounted to the trailer and coupled to the inlets via the gas pipeline, the choke configured to reduce an incoming gas pressure to an outgoing gas pressure of about 50 PSI; a heater unit mounted to the trailer and connected downstream from the choke via pipeline; and a pair of outlets downstream from the heater unit mounted to the platform on the trailer on a respective left and right side of the trailer.

In one aspect, an embodiment may provide a method comprising the steps of: positioning a transportable choke at a site; parking a first pressure vessel mounted on a first vehicle and carrying compressed CNG therein near the transportable choke; moving the compressed CNG from the first pressure vessel through the choke to decrease the pressure of the CNG; parking a second pressure vessel mounted on a second vehicle and carrying compressed CNG therein near the transportable choke; and moving the compressed CNG from the second pressure vessel through the choke to decrease the pressure of the CNG.

In yet another aspect, one embodiment may provide a mobile CNG pressure reducing choke and heater unit mounted to a trailer. The trailer is towable to a location that does not have a sales pipeline of CNG. Clean gas that has already been processed from a compressed storage station facility is input into the inlets. The CNG then flows through a series of valves and then through the choke. The choke on the trailer chokes down the pressure of CNG directly from a compressed tank, usually on a separate semi-tractor. The CNG is then heated, and used on site. The CNG input to this system may come from two distinct sources such that the pressure reduction can continuously occur without any readily observable delay by the user. There are outlet ports to connect to a diesel engine converted to run on CNG.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims. The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side elevation view of the present invention including a moveable platform, a choke connected to the platform, and a heater unit connected to the platform;

FIG. 2 is an enlarged side elevation view of the present invention shown from a drop neck section on a trailer rearwardly;

FIG. 3 is a top view of the present invention depicted in FIG. 2;

FIG. 4 is an enlarged top view of the call out box labeled “See FIG. 4” in FIG. 3;

FIG. 5 is an enlarged top view of the choke and a bypass valve indicated in the call out box labeled “See FIG. 5” in FIG. 4;

FIG. 6 is a cross-section view taken along line 6-6 in FIG. 4;

FIG. 7 is a top view of an operational embodiment of the present invention depicting a first vehicle positioned along the side of the trailer;

FIG. 8 is a top view of an operational embodiment of the present invention depicting a second vehicle on an opposite side of the trailer;

FIG. 9 is a top view of an operational embodiment of the present invention depicting the first vehicle driving away from the trailer; and

FIG. 10 is a flow chart of an exemplary method of the present invention.

Similar numbers refer to similar parts throughout the drawings.

### DETAILED DESCRIPTION

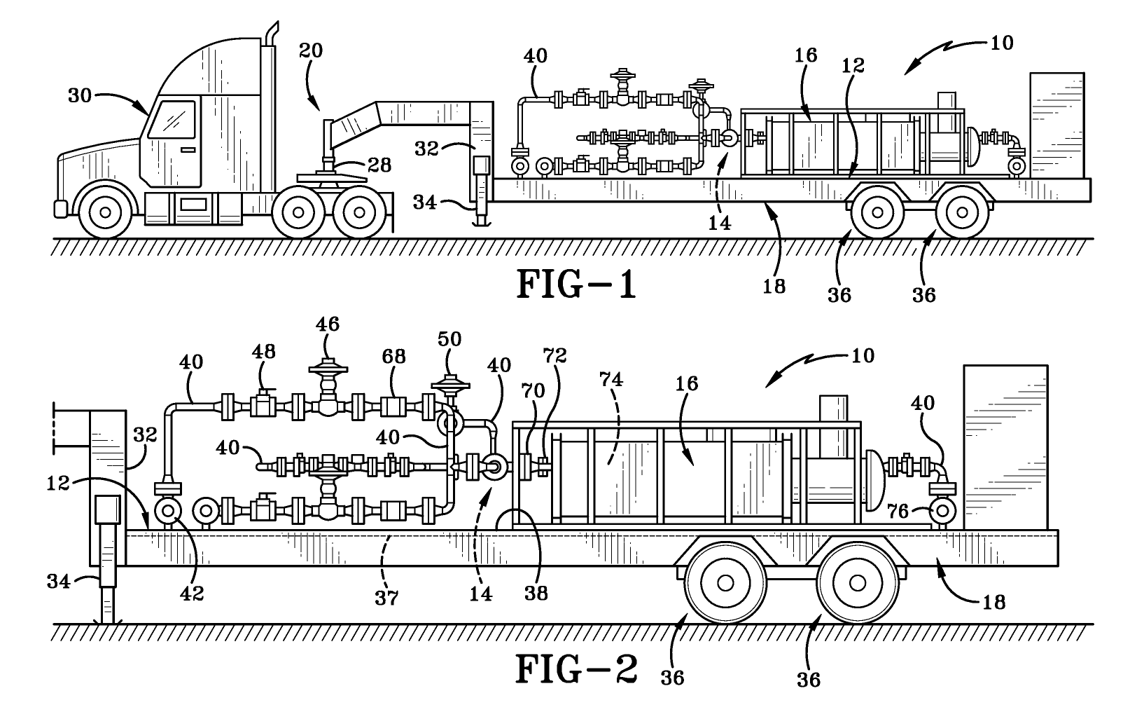

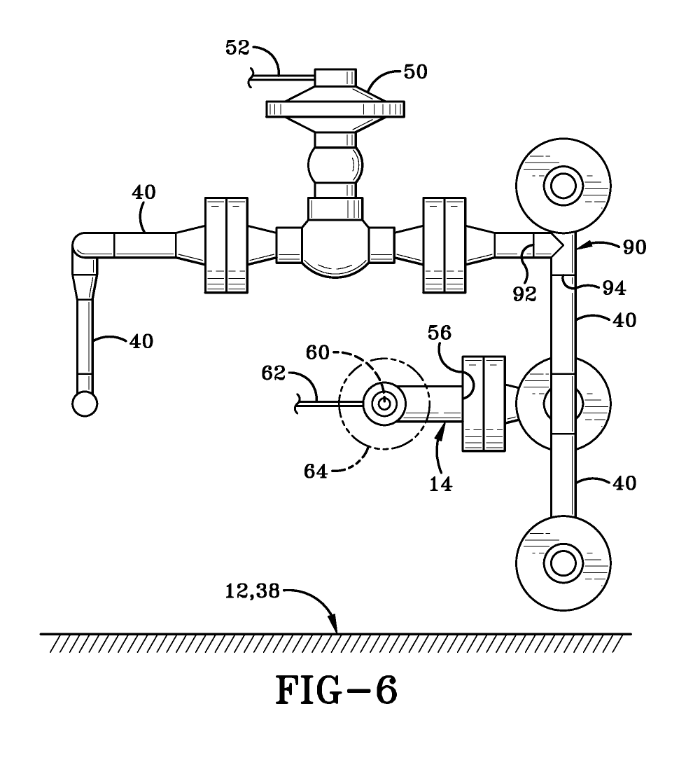

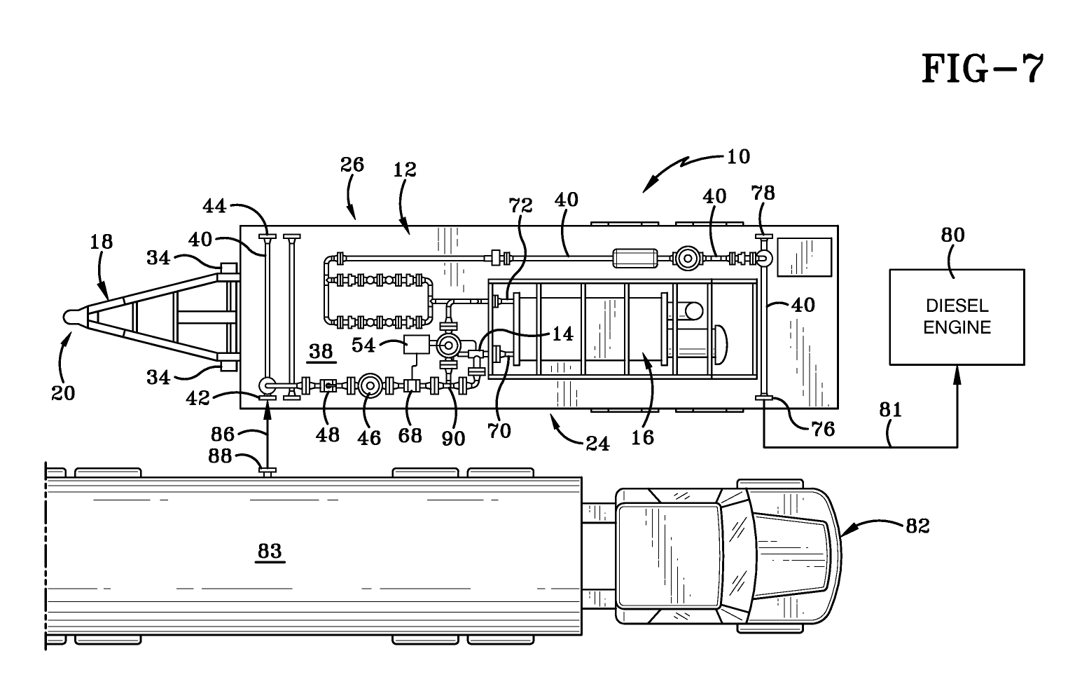

A transportable gas device and system of the present invention as depicted throughout FIGS. 1-10 and is shown generally as 10. System 10 includes a moveable platform 12, choke 14, and heater 16.

As depicted in FIG. 1 and FIG. 2, platform 12 is on a trailer 18. Trailer 18 includes a front end 20 spaced apart from a rear end 22 defining a longitudinal direction therebetween. Trailer 18 further includes a left side 24 spaced apart from a right side 26 defining a transverse direction therebetween. Trailer 18 includes a fifth wheel hitch 28 near the forward end 20 for connecting the trailer 18 to a vehicle 30 such as a tractor-truck. In one particular embodiment, trailer 18 includes a drop neck section 32 positioned slightly rearwardly from the front end 20. Drop neck section 32 includes a pair of downwardly extending landing gear arms 34 to engage the ground when front end hitch is disconnected from the vehicle 30. Further, drop neck section 32 permits platform 12 on trailer 18 to sit at a lower vertical height than a conventional flat platform on the trailer which is advantageous as some state laws may have height limitations for a commercial vehicle. The platform 12 extends rearwardly from the drop neck section 32 and terminates at the end of the platform 12 defining the rear end 22 of the trailer 18. Platform 12 further includes an upwardly facing top surface 38 and opposite a downwardly facing bottom surface 37. A conventional suspension and wheel assembly 36 is connected to the trailer 18 beneath the bottom surface 37 of platform 12 adjacent the rear end 22 of trailer 18.

As depicted in FIG. 2 and FIG. 3, gas pipeline 40 is connected to the platform 12 in various locations. An inlet 42 to the gas pipeline 40 is mounted to the trailer 18, and in one particular embodiment an inlet 42 is positioned above the top surface 38 of platform 12. Further, in an additional particular embodiment, a second inlet 44 is in fluid communication with the pipeline 40 and mounted near a side of the trailer 18 different than that of the first inlet 42. In one shown embodiment, a first inlet 42 is mounted on the left side 24 of the trailer 18 and a second inlet 44 is mounted on the right side 26 of the trailer 18. The purpose of this configuration will be explained in later detail with respect to compressed natural gas flowing through said pipeline from two distinct source containers located on delivery vehicles.

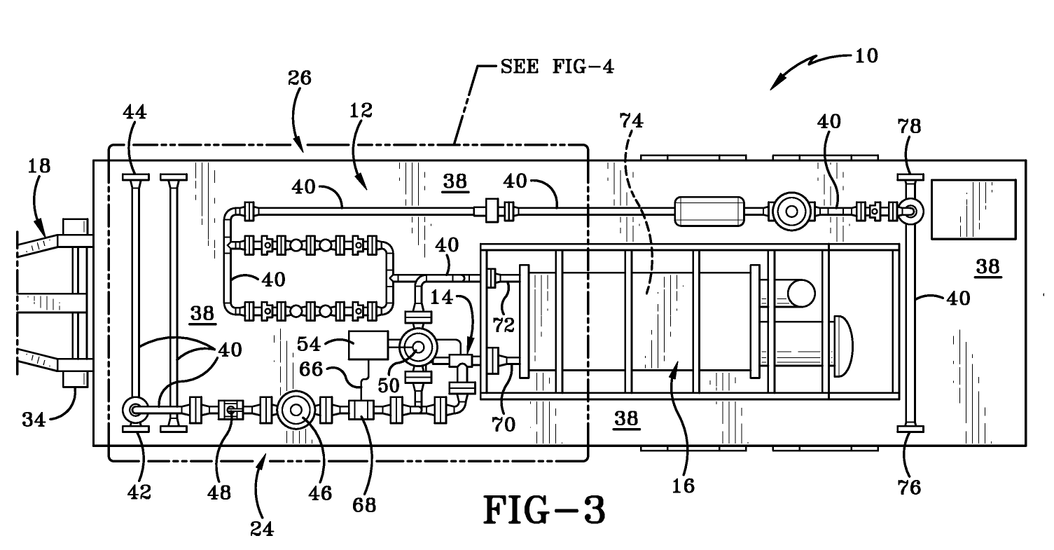

As depicted in FIG. 4, a series of motor valves 46 and manual valves 48 are located along the pipeline 40 between the inlet 44 and the choke 14. One such valve is a bypass valve 50 positioned along the pipeline 40 in parallel flow with the choke 14. Bypass valve 50 is configured to cause CNG to bypass the choke 14 when the pressurized CNG flowing through the pipeline 40 is at a pressure value (approximately 50 PSI) that is able to be fed into a converted diesel engine configured to run on CNG. Bypass valve 50 is in electrical communication 52 with a computer 54 having logic to control said bypass valve 50.

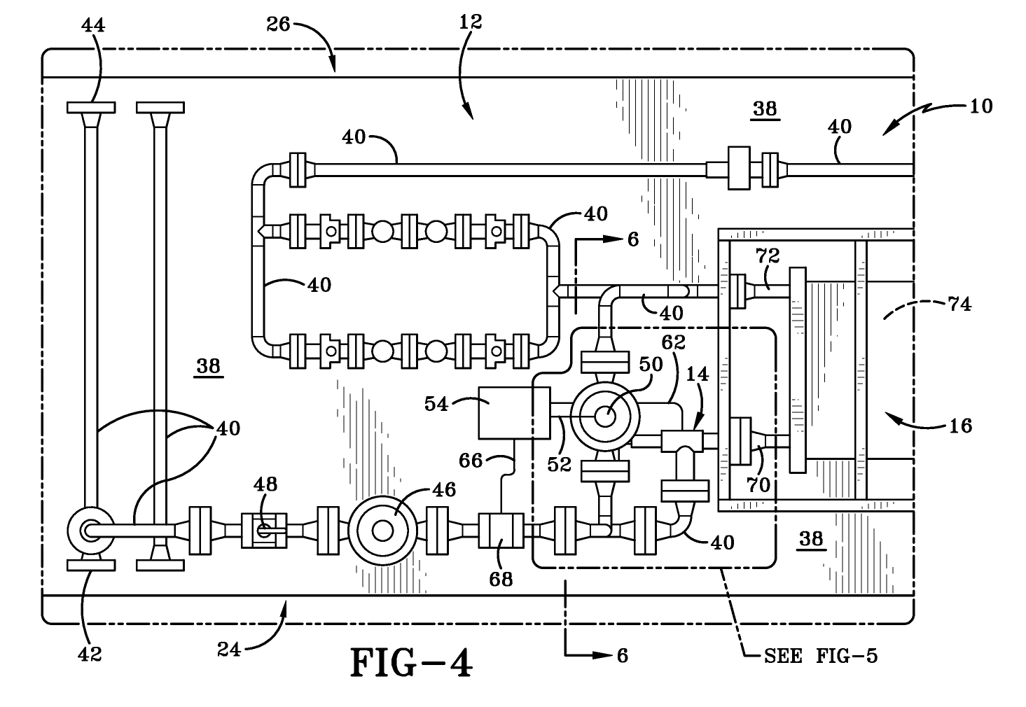

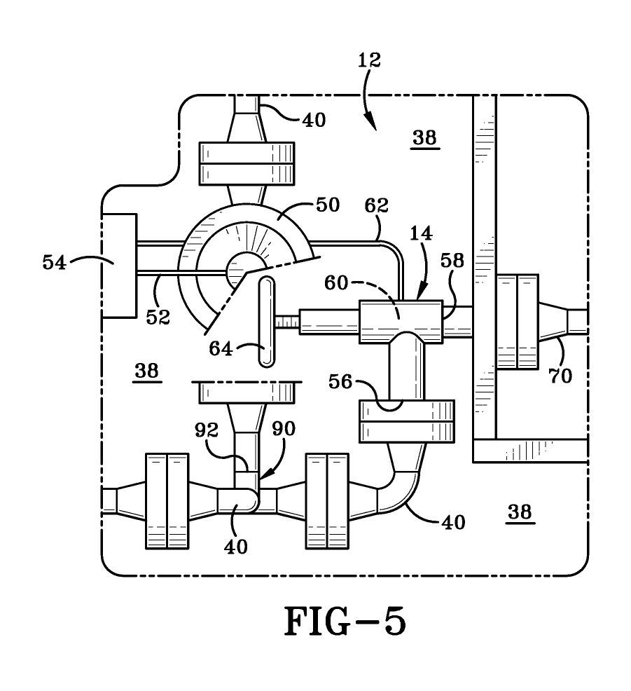

As depicted in FIG. 5, the choke 14 is connected in fluid communication along pipeline 40 and aligned in fluid parallel communication with bypass valve 50. Choke 14 includes an inlet 56 and an outlet 58. Choke 14 further includes an adjustable orifice 60 within the choke 14 to adjust the pressure of CNG flowing from upstream to downstream through said choke 14. Orifice diameter may be varied to adjust the pressure of CNG flowing therethrough. Preferably, choke 14 is an electrically controlled choke. One particular non-limiting example of an electrically controlled choke is available commercially for sale under the name Severe Service Choke, model number CVC-ME, sold by T3 Energy Service, a unit of Robbins & Myers, Inc. of Houston, Tex.

In one particular embodiment, the orifice 60 is in electrical communication 52 with the computer 54 and logic which adjusts the orifice 60 diameter in accordance with preset computer software conditions. The logic may be contained in the same computer 54 as logic of the bypass valve 50 or may be a separate and distinct unit as one having ordinary skill in the art would understand. However, in an additional alternative embodiment, orifice 60 of choke 14 may be attached to a manual wheel 64 selectively rotatable by a user to adjust the orifice size.

A non-limiting example of the manner in which the computer 54 or computing device may operate is described in the following manner. The example computing device may be the computer 54 that includes a processor, a memory, and input/output ports operably connected by a bus. In one example, the computer may include a pressure logic configured to calculate the pressure, via connection 66 to sensor 68, of CNG in the pipeline 40 to determine whether to activate bypass valve 50 or to adjust orifice 60 size inside the choke 14. In different examples, the logic may be implemented in hardware, software, firmware, and/or combinations thereof. Thus, the logic may provide means (e.g., hardware, software, and firmware) for calculating CNG pressure flowing through the pipeline 40 to determine whether to activate the bypass valve 50 or adjust the orifice 60 inside the choke 14. While the logic can be a hardware component attached to the bus, it is to be appreciated that in one example, the logic could be implemented in the processor.

Generally describing an example configuration of the computer 54, the processor may be a variety of various processors including dual microprocessor and other multi-processor architectures. A memory may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk may be operably connected to the computer via, for example, an input/output interface (e.g., card, device) and an input/output port. The disk may be, for example, a magnetic disk drive, a solid state disk drive, a floppy disk drive, a tape drive, a Zip drive, a flash memory card, and/or a memory stick. Furthermore, the disk may be a CD-ROM, a CD recordable drive (CD-R drive), a CD rewriteable drive (CD-RW drive), and/or a digital video ROM drive (DVD ROM). The memory can store a process and/or a data, for example. The disk and/or the memory can store an operating system that controls and allocates resources of the computer.

The bus may be a single internal bus interconnect architecture and/or other bus or mesh architectures. While a single bus is illustrated, it is to be appreciated that the computer may communicate with various devices, logics, and peripherals using other busses (e.g., PCIE, SATA, Infiniband, 1394, USB, Ethernet). The bus can be types including, for example, a memory bus, a memory controller, a peripheral bus, an external bus, a crossbar switch, and/or a local bus.

The computer may interact with input/output devices via the I/O interfaces and the input/output ports. Input/output devices may be, for example, pressure sensors 68, a keyboard, a microphone, a pointing and selection device, cameras, video cards, displays, the disk, the network devices, and so on. The input/output ports may include, for example, serial ports, parallel ports, and USB ports.

The computer 54 can operate in a network environment and thus may be connected to the network devices via the I/O interfaces, and/or the I/O ports. Through the network devices, the computer may interact with a network. Through the network, the computer may be logically connected to remote computers. Networks with which the computer may interact include, but are not limited to, a local area network (LAN), a wide area network (WAN), and other networks. The networks may be wired and/or wireless networks.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

The heater unit 16 is connected to the trailer 18. In one particular embodiment, the heater unit 16 is mounted on the top surface 38 of the platform 12. Heater 16 includes an inlet 70 and an outlet 72, wherein said inlet 70 of the heater 16 is in fluid communication with the outlet 58 from the choke 14. Heater 16 is a boxlike structure therein containing a heat exchanging pipeline 74 submerged in a heat exchanging fluid leading to the outlet 72 along the heat exchanging pipeline 74. The heater 16 warms or heats CNG gas moving through the submerged heat exchanging pipeline 74 in the heated fluid downstream from the choke 14. The heater 16 is necessary because with about every 100 PSI reduced by the choke 14, the CNG loses about 7° F. Thus, if CNG is moving through the inlet is around 3500 PSI and it is being choked down to a reduced pressure of about 50 PSI downstream from the choke 14, an extreme pressure drop occurs and if the heater 16 was not present, the CNG would freeze up and be un-usable. Thus, the heater 16 keeps the CNG at a high enough temperature such that the CNG is usable and not frozen.

An outlet 72 from the heater 16 is connected via pipeline to at least one outlet 76 on the side of the trailer 18. In the shown embodiment, a second outlet 78 is in fluid communication with the pipeline 40 downstream from the heater 16 and mounted to the trailer 18 at a location on a side different than that of the first outlet 76. The purpose of two outlets 76, 78 being located on opposite sides, or at least different sides, of the trailer 18 is that two separate and distinct diesel engines 80 that have been converted to run on CNG may be connected to the outlets to run devices located at a well site without physically interfering with each other.

In accordance with one aspect of an embodiment of the present invention, the transportable gas device 10 permits a user, such as a well drilling company, to operate a diesel engine converted to run on CNG at a location where a normal CNG sales pipeline does not exist.

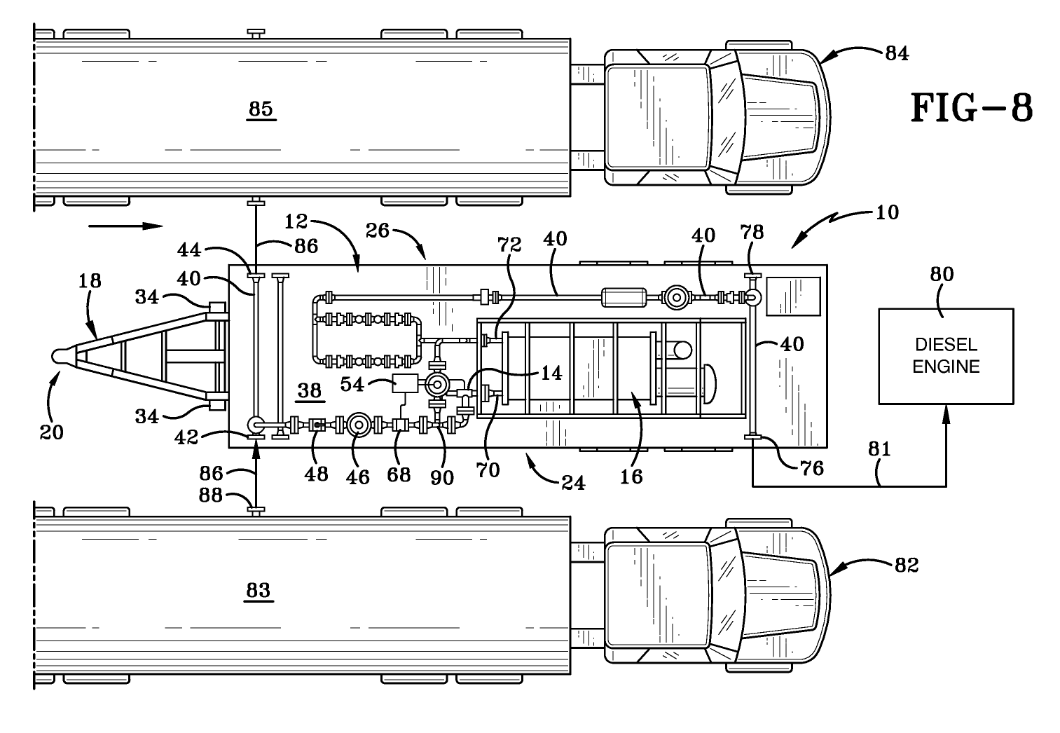

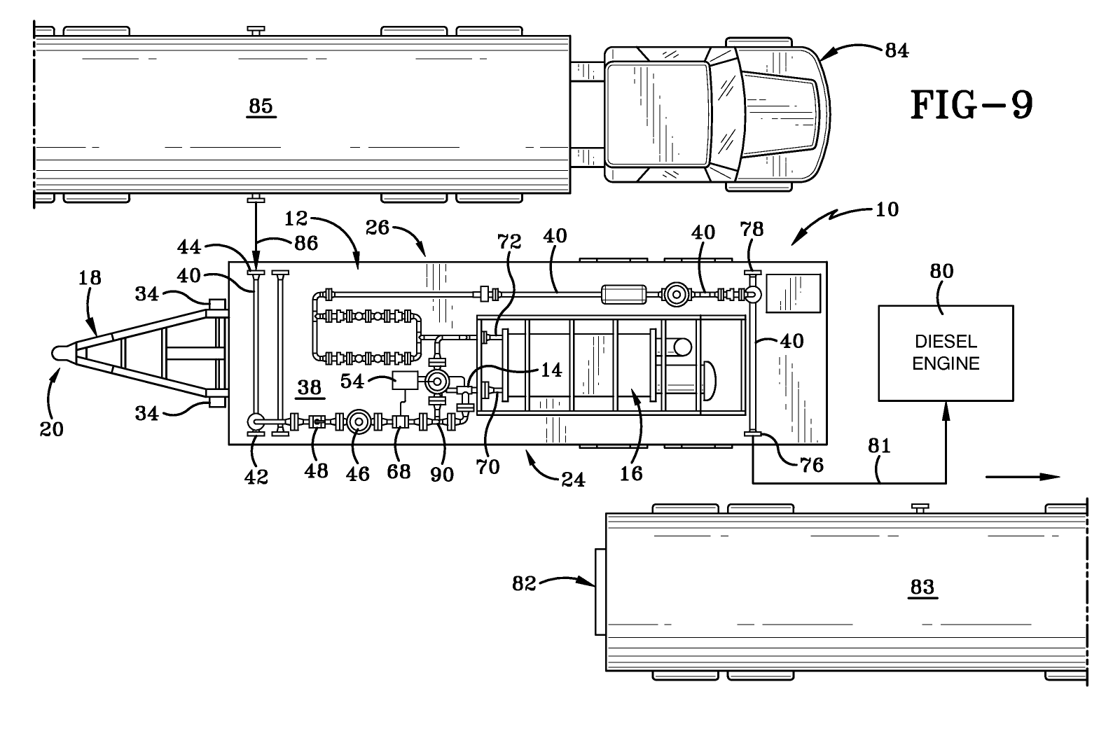

In operation and with reference to FIG. 7, FIG. 8, and FIG. 9, a user provides the moveable platform 12 in the form of a trailer 18 including the choke 14 and the heat exchanging unit 16 mounted thereon. The trailer 18 is towed to a remote site. In one particular embodiment, the remote site is a fossil fuel well pumping or extracting facility. The remote site contemplated in the present invention is free of any CNG sales pipeline leading to the site that would allow a diesel engine converted to run on sales pipeline quality CNG to operate at the remote site. The trailer 18 is secured at the remote site via landing gear 34 and positioned in a manner such that the sides 24, 26 are relatively free from obstructions allowing a first hauling vehicle 82 including a pressure vessel tank 83 filled with highly pressurized CNG to park adjacent either side of the trailer 18.

The hauling vehicle 82 having a pressure vessel tank 83 mounted thereon preferably approaches the trailer 18 from one end, either the front end 20 or the rear end 22. The vehicle 82 pulls up and aligns with an inlet 42 on a side of the trailer 18. An user then connects, via pipeline or tubing 86, an outlet 88 of the pressure vessel tank 83 filled with compressed CNG on the vehicle 82 to the inlet 42 on the side of the trailer 18.

In one particular embodiment, the hauling vehicle 82 CNG is stored within pressure vessel tank 83 at a pressure of approximately 3,500 PSI. The CNG contained in the pressure vessel 83 has been loaded or filled into the pressure vessel at an off-site facility by conventionally known methods as one having ordinary skill in the oil and gas art would understand. Similarly, the manner in which the CNG flows outwardly from the pressure vessel through the outlet into the inlet on the trailer 18 may be accomplished by means ordinarily understood in the art, such as a pump or under free flow via the CNG's own differential pressure.

The CNG enters pipeline 40 through the inlet 42 and flows downstream towards a T-fitting 90 passing valves 46, 48 and pressure sensor 68 along the way. The gas flows into one end of the T-fitting 90 and out two outlets 92, 94. The bypass valve 50 is fluidly coupled to the first outlet 92 of the T-fitting 90 and the second outlet 94 of the T-fitting 90 is fluidly coupled to the choke 14. When the bypass valve 50 is closed the gas flows through the T-fitting 90 towards the choke 14. Gas enters through the choke inlet 56 and then approaches an orifice 60 inside the choke 14. The orifice 60 in the choke 14 is configured to reduce the pressure of the CNG flowing therethrough.

In one particular embodiment, the choke 14 reduces the pressure of the CNG flowing therethrough from a pressure of about 3500 PSI upstream from the choke 14 to a downstream pressure of about 50 PSI. It should be noted that the pressure of the CNG upstream from the choke 14 decreases as CNG fuel is depleted from the pressure vessel tank 83 on the hauling vehicle 82 as time goes on and more CNG passes through the orifice 60 inside the choke 14. One exemplary purpose of reducing the CNG gas pressure in the pipeline to about 50 PSI is so that a converted diesel engine 80 converted to run on CNG may be fed through an engine inlet with CNG. Converted diesel engines 80 ordinarily require an inlet CNG pressure of about 50 PSI.

After moving through the choke 14, the less-pressurized CNG, now at about 50 PSI, flows through a heater unit 16. The heater unit 16 includes a heat exchanging pipeline 74 submerged in a heated fluid bath extending from an inlet 70 downstream to an outlet 72. The less-pressurized CNG flows through the heat exchanger pipeline, the heated fluid contacts the submerged pipe 74 thereby imparting heat to the gas flowing downstream from inlet 70 to outlet 72, through the heater unit 16. One particular non-limiting purpose of the heater unit is to heat the gas as the pressure decreases. Ordinarily, CNG loses about 7° F. for every 100 PSI dropped in a pressure reducer (i.e., the choke 14). Thus, if a heater unit is not downstream from the choke 14, the less-pressurized CNG, at about 50 PSI, would condense into a liquid and then freeze into a solid downstream from the choke 14. Thus, heating the fuel after decreasing the fuel pressure prevents condensation of the fuel into a liquid and further prevents freezing into a solid phase material. The gas flows downstream from the outlet 72 on the heater unit towards an outlet 76 connected to platform 12 on the trailer 18. The outlet 76 on the trailer 18 is placed in an area that allows a converted diesel engine 80 to connect thereto via pipeline or tubing 81 to allow it to operate at the remote site.

Reference is now made to the operation of the bypass valve 50 connected to one outlet 92 of the T-fitting 90 mounted fluidly in parallel with the choke 14. The bypass valve 50 is electrically coupled 52 to the computer 54. The computer 54 is configured to monitor the pressure of the CNG in the pipeline upstream from the choke 14 via sensor 68. As the CNG is depleted from the pressure vessel 83 moving through the choke 14, the computer 54 continuously, or at least regularly, monitors the upstream pressure via sensor 68. When the upstream pressure approaches 50 PSI, the heating of gas downstream from the choke 14 is no longer necessary. Thus, when CNG upstream from the choke 14 nears 50 PSI the computer actuates the bypass valve 50 to open said bypass valve 50 while simultaneously actuating the adjustable orifice 60 inside the choke 14 to close it. This allows gas to flow through the bypass valve 50 directly to the outlet 76 mounted on the trailer 18 without having to go through the choke 14 and heater unit 16.

In operation, and with continued reference to FIG. 7, FIG. 8, and FIG. 9, the moveable platform 12 on the trailer 18 has a first inlet 42 and a second inlet 44 connected thereto. In this particular embodiment a hauling vehicle 82 approaches one side of the trailer 18 to connect its CNG to the first outlet. CNG is depleted from the first pressure vessel 83 on the first vehicle 82 in the manner described above. While the first pressure vessel 83 is depleting its contents through the gas system, the choke 14, and the heater unit 16, a second valve, similar to that of 46 or 48, at or near second inlet 44 may be closed.

A second vehicle 84 carrying a second pressure vessel 85 may pull up and park next to the second inlet 44 and on a side different than that of the first inlet. In the shown embodiment, the second inlet 44 is located on the right side 26 of the trailer 18. An user may connect the second pressure vessel 85 on the second vehicle 84 containing CNG to the second inlet 44 via pipeline or tubing 86. As the first pressure vessel depletes its CNG payload to a nearly empty point the computer 54 may electronically close a valve at or near the first inlet while simultaneously opening the valve at or near the second inlet 44. This stops the flow of CNG from the first pressure vessel 83 and starts the flow of CNG from the second pressure vessel 85 without significant delay as observed by the user/user, or in real time.

The first vehicle 82 may then disconnect from the first inlet 42 and drive away from the trailer 18. Preferably, the first vehicle 82 will drive to a CNG refilling station where it can refill with CNG and drive back to the trailer 18 to re-connect with the first inlet 42 such that a similar cycle can be repeated wherein the computer 54 will actuate the second valve near the second inlet 44 as the second pressure vessel 85 nears depletion and the valve near the first inlet 42 may be actuated open such the first pressure vessel 83 carrying a new payload of CNG continues to flow through the pipeline 40 without significant delay as observed by the user. This cycle continues until the user no longer desires to operate an engine 80 at the remote site with the CNG moving through the system 10. Further, while this embodiment is described as only using two vehicles 82, 84, there may be a third, a fourth, a fifth, a sixth hauling vehicle, and so on, depending on how far the CNG filling station is located from the trailer 18 parked at the remote site.

In further operation, one embodiment of the present invention depicts a first outlet 76 and a second outlet 78 mounted on different sides of the trailer 18, shown left and right sides, configured to operate two separate and distinct converted diesel engines at the remote site. While the two outlets are shown, it could clearly be understood by one having ordinary skill in the art that there may only be one outlet, or there may be three or more outlets, all depending on how many converted diesel engines the remote site user desires to run at a given time. Further, each outlet may include a valve electronically connected to the computer to be actuated at a desired time as one having ordinary skill in the art would understand.

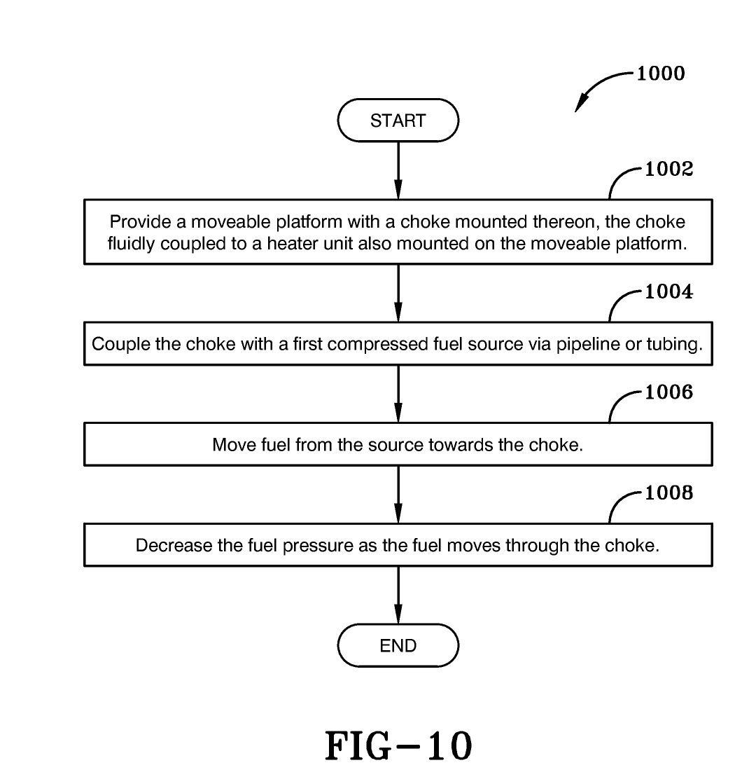

In operation and with reference to FIG. 10, a method is shown generally at 1000. Method 1000 comprises the steps of: providing a moveable platform with a choke mounted thereon, the choke fluidly coupled to a heater unit also mounted on the moveable platform, shown generally at 1002; coupling the choke with a first compressed fuel source via pipeline or tubing, shown generally at 1004; moving fuel from the source towards the choke, shown generally at 1006; and decreasing the fuel pressure as the fuel moves through the choke, shown generally at 1008.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

What is claimed:

1. A transportable gas device comprising:
a moveable platform;
a choke connected to the moveable platform configured to decrease pressure of compressed fuel moving therethrough; and
a heater unit connected to the moveable platform in downstream fluid communication with the choke to warm the compressed fuel after the pressure has been decreased by the choke.

2. The device of claim 1, further comprising:
a first inlet;
a second inlet spaced apart from the first inlet; and
wherein the first and second inlets allow at least two distinct fuel sources to fluidly connect with the choke.

3. The device of claim 2, wherein the first inlet is connected near a first side of the platform and the second inlet is connected near a side of the platform different than that of the first inlet.

4. The device of claim 1, further comprising:
a first outlet;
a second outlet spaced apart from the first outlet; and
wherein the first and second outlets allow at least two distinct combustion engines to fluidly connect with the choke.

5. The device of claim 4, wherein the first outlet is near a first side of the platform and the second outlet is near a side of the platform different than that of the first outlet.

6. The device of claim 1, further comprising:
a trailer including a forward end hitch assembly connected to the platform forwardly from a rear suspension assembly and ground-engaging wheels;
wherein the platform defines the top surface of the trailer.

7. The device of claim 6, wherein the trailer is a drop-neck trailer.

8. The device of claim 1, further comprising:
a heater pipeline coupled to the choke and submerged in a heating liquid retained in the heater.

9. The device of claim 1, further comprising:
computer logic in communication with the choke configured to adjust an orifice within the choke according to fuel pressure input.

10. The device of claim 1, further comprising:
a selectively operable bypass valve installed on the platform and fluidly in parallel with the choke; and
a computer electronically connected to the bypass valve and the choke to selectively operate each of the bypass valve and the choke.

11. A method comprising the steps of:
providing a choke fluidly coupled to a heater unit, the choke and heater mounted on a moveable platform;
transporting the choke and heater to a site location;
coupling the choke with a first compressed fuel source via pipeline or tubing;
moving fuel from the source towards the choke; and
decreasing the fuel pressure as the fuel moves through the choke.

12. The method of claim 11, wherein the step of decreasing the fuel pressure results in a fuel pressure of 50 PSI downstream from the choke.

13. The method of claim 11, further comprising the steps of:
heating the fuel after decreasing the fuel pressure to prevent condensation of the fuel.

14. The method of claim 11, further comprising the steps of:
transporting the choke and heater on the moveable platform to a site location remote from a conventional sales pipeline for distributing compressed fuel; and
transporting a first vehicle carrying the compressed fuel source to the site location.

15. The method of claim 11, further comprising the steps of:
positioning a first vehicle carrying the compressed fuel source in a container adjacent the choke and heater on the moveable platform;
coupling the container to a first inlet, said first inlet in fluid communication with the choke;
positioning a second vehicle carrying the compressed fuel source in a second container adjacent the choke and heater on the moveable platform; and
coupling the container to a second inlet, said second inlet in fluid communication with the choke.

16. The method of claim 11, further comprising the steps of:
coupling the choke with a second compressed fuel source via pipeline or tubing;
depleting the first compressed fuel source;
actuating a valve to direct fuel from the second fuel source into the choke, without significant delay as observed by a user, when the first compressed fuel source is nearly empty; and
depleting the second compressed fuel source.

17. The method of claim 16, wherein the step of actuating the valve to direct fuel from the second source to the choke occurs when the pressure in the first compressed fuel source reaches about 50 PSI.

18. The method of claim 11, further comprising the steps of:
coupling an engine to a first outlet coupled with the choke and heater; and
powering the engine with fuel decreased in pressure as the fuel moved through the choke on the platform.

19. The method of claim 18, further comprising the steps of:
coupling a second engine to a second outlet mounted on the platform; and
powering the second engine simultaneously with the first engine with fuel moved through the choke on the platform.

20. The method of claim 11, further comprising the steps of:
parking a first pressure vessel mounted on a first vehicle and carrying compressed natural gas (CNG) therein near the choke;
moving the CNG from the first pressure vessel through the choke to decrease the pressure of the CNG;
parking a second pressure vessel mounted on a second vehicle and carrying CNG therein near the transportable choke; and
moving the CNG from the second pressure vessel through the choke to decrease the pressure of the CNG as the CNG from the first pressure vessel is nearing depletion.
